(19) United States
(12) Patent Application Publication
(10) Pub. No.: US 2025/0391613 A1
(43) Pub. Date: Dec. 25, 2025

(54) CAPACITOR ELEMENT

(71) Applicant: Murata Manufacturing Co., Ltd., Nagaokakyo-shi (JP)

(72) Inventor: Kazutaka NAKAMURA, Nagaokakyo-shi (JP)

(21) Appl. No.: 19/316,050

(22) Filed: Sep. 2, 2025

Related U.S. Application Data
(63) Continuation of application No. PCT/JP2024/007014, filed on Feb. 27, 2024.

(30) Foreign Application Priority Data
Mar. 10, 2023 (JP) 2023-038069

(51) Int. Cl. H01G 9/10; H01G 9/26

(52) U.S. Cl. CPC H01G 9/10; H01G 9/26

(57) ABSTRACT

A capacitor element that includes: a capacitor unit including an anode plate including a core portion and a porous portion on at least one main surface of the core portion, a dielectric layer on a surface of the porous portion, and a cathode layer that includes a solid electrolyte layer on a surface of the dielectric layer, and the solid electrolyte layer contains a conductive polymer; and a sealing layer covering the capacitor unit, wherein the sealing layer contains a first insulating resin and first flattened inorganic fillers, and the first flattened inorganic fillers are oriented in a surface direction orthogonal to a thickness direction in a portion of the sealing layer that covers the capacitor unit.

### CROSS REFERENCE TO RELATED APPLICATIONS

The present application is a continuation of International application No. PCT/JP2024/007014, filed Feb. 27, 2024, which claims priority to Japanese Patent Application No. 2023-038069, filed Mar. 10, 2023, the entire contents of each of which are incorporated herein by reference.

### TECHNICAL FIELD

The present disclosure relates to a capacitor element.

### BACKGROUND ART

Patent Document 1 discloses a capacitor array including a plurality of solid electrolytic capacitor elements formed by dividing a single solid electrolyte capacitor sheet, a sheet-like first sealing layer, and a sheet-like second sealing layer. The solid electrolyte capacitor sheet described above includes an anode plate made of a valve metal, a porous layer provided on at least one main surface of the anode plate, a dielectric layer provided on a surface of the porous layer, and a cathode layer, provided on a surface of the dielectric layer, that includes a solid electrolyte layer and has a first main surface and a second main surface that face away from each other in a thickness direction. The first main surfaces of the plurality of solid electrolytic capacitor elements are disposed on the first sealing layer. The second sealing layer is disposed so as to cover, from the second main surface, the plurality of solid electrolytic capacitor elements on the first sealing layer. The solid electrolytic capacitor elements described above are divided by slit-shaped sheet removal portions.

Patent Document 1: Japanese Unexamined Patent Application Publication No. 2020-167361.

### SUMMARY OF THE DISCLOSURE

In the capacitor array described in Patent Document 1, when oxygen and moisture from the outside diffuse and infiltrate to the solid electrolytic capacitor element via the sealing layer, the conductive polymer contained in the solid electrolyte layer may degrades over time. Since the solid electrolyte layer becomes likely to peel off from the dielectric layer due to a stress in this case, a decrease in electrostatic capacity and equivalent series resistance (ESR) is caused, and, in some cases, delamination may be caused.

Patent document 1 describes that a stress relief layer may be provided between the solid electrolytic capacitor element and the first sealing layer or the second sealing layer and that a stress relief layer may also be provided in a sheet removal portion between adjacent solid electrolytic capacitor elements. Patent document 1 describes that the stress relief layer is preferably made of an insulating resin, such as epoxy resin, phenolic resin, or silicone resin and that the stress relief layer preferably further includes inorganic fillers, such as silica particles, alumina particles, or metal particles.

According to Patent Document 1, by the stress relief layer being provided at the position described above, it is possible to relief the stress generated between the inside and outside of the capacitor array without degradation of the capabilities (such as resistance and blocking performance) required for the conductor portion and the insulating portion disposed on the outermost portion of the solid electrolytic capacitor element and the capabilities (such as ease of close contact with wiring and ease of smooth formation) required for the sealing layer. However, there is room for improvement in suppressing permeation of oxygen and moisture to the solid electrolytic capacitor element.

It should be noted that the problem described above occurs not only in the structure in which a plurality of capacitor units are disposed in the sealing layer but also in the structure in which a single capacitor unit is disposed in the sealing layer.

The present disclosure has been made to solve the problem described above and an object thereof is to provide a capacitor element in which oxygen and moisture do not easily permeate through the sealing layer to the capacitor unit.

A capacitor element according to the present disclosure includes: a capacitor unit including an anode plate including a core portion and a porous portion on at least one main surface of the core portion, a dielectric layer on a surface of the porous portion, and a cathode layer that includes a solid electrolyte layer on a surface of the dielectric layer, and the solid electrolyte layer contains a conductive polymer; and a sealing layer covering the capacitor unit, wherein the sealing layer contains a first insulating resin and first flattened inorganic fillers, and the first flattened inorganic fillers are oriented in a surface direction orthogonal to a thickness direction in a portion of the sealing layer that covers the capacitor unit.

According to the present disclosure, it is possible to provide a capacitor element in which oxygen and moisture do not easily pass through the sealing layer to the capacitor unit.

### BRIEF DESCRIPTION OF THE DRAWINGS

FIG. 1 is a cross-sectional view schematically illustrating an example of a capacitor element according to the present disclosure.

FIG. 2 is a plan view of the capacitor element illustrated in FIG. 1 taken along line II-II.

FIG. 3 is an enlarged view of the portion indicated by III in FIG. 1.

FIGS. 4A and 4B are schematic diagrams for describing the oblateness of inorganic fillers.

FIGS. 5A, 5B, and 5C are schematic diagrams for describing an example of a method of forming a sealing layer.

FIG. 6 is a graph illustrating the temporal change (ESR ratio) of ESR at 100 kHz.

FIG. 7 is a graph illustrating the temporal change (ACs) of electrostatic capacity at 120 kHz.

### DESCRIPTION OF THE PREFERRED EMBODIMENTS

A capacitor element according to the present disclosure will be described. It should be noted that the present disclosure is not limited to the following structure and may be changed as appropriate without departing from the spirit of the present disclosure. In addition, the present disclosure also includes a combination of a plurality of preferred structures described below.

In this specification, terms that indicate the relationship between elements (such as vertical, parallel, and orthogonal) and terms that describe the shapes of elements are do not represent strict meanings and include substantially equivalent ranges, for example, differences of several percent.

The diagrams illustrated below are schematic diagrams, and the dimensions, the aspect ratios, and scales may differ from those of the actual product. In the drawings, the same reference numerals are used for identical or corresponding components. In addition, in the drawings, the same elements are denoted by the same reference numeral to omit redundant descriptions.

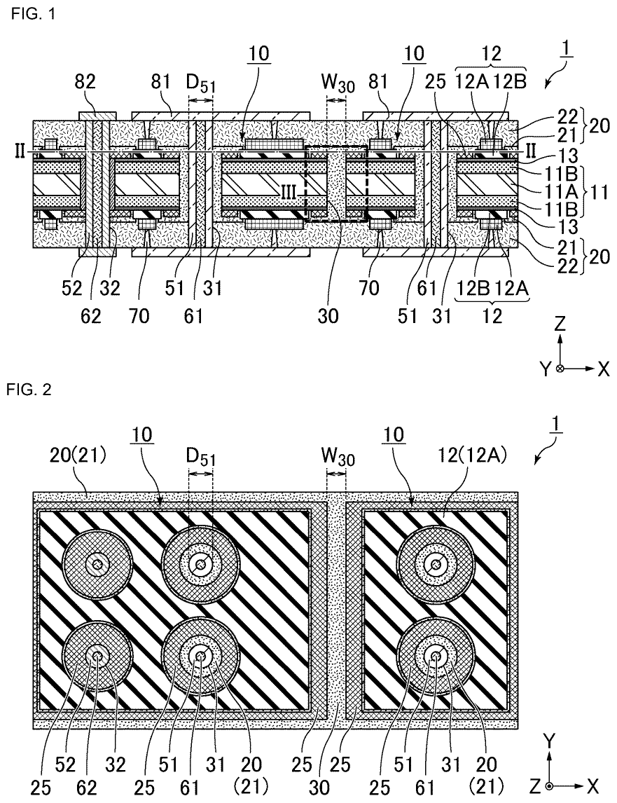

FIG. 1 is a cross-sectional view schematically illustrating an example of the capacitor element according to the present disclosure. FIG. 2 is a plan view of the capacitor element illustrated in FIG. 1 taken along line II-II.

The capacitor element 1 illustrated in FIGS. 1 and 2 includes capacitor units 10 and a sealing layer 20 provided so as to cover the capacitor unit 10. In the example illustrated in FIG. 1, the sealing layer 20 includes a first sealing layer 21 that covers the capacitor units 10 and a second sealing layer 22 that covers the first sealing layer 21.

In the example illustrated in FIGS. 1 and 2, the two capacitor units 10 are disposed in the sealing layer 20. The number of capacitor units 10 disposed in the sealing layer 20 is not particularly limited and may be one or more.

As illustrated in FIGS. 1 and 2, when the plurality of capacitor units 10 are disposed in the sealing layer 20, adjacent capacitor units 10 are preferably separated from each other by a through-groove 30 that passes through the capacitor units 10 in a thickness direction (Z direction). In this case, the through-groove 30 is preferably filled with an insulating material, such as the sealing layer 20.

When adjacent capacitor units 10 are separated from each other by the through-groove 30, the adjacent capacitor units 10 only need to be physically separated by the through-groove 30. Accordingly, the adjacent capacitor units 10 may be electrically separated from each other or electrically connected. The width of the through-groove 30, that is, the spacing between the adjacent capacitor units 10, may be constant in the thickness direction (Z direction) or may decrease in the thickness direction.

When a plurality of capacitor units 10 are disposed in the sealing layer 20, the plurality of capacitor units 10 may be disposed so as to be arranged in a surface direction (that is, in a surface direction parallel to the X-axis and the Y-axis) orthogonal to the thickness direction (Z direction), may be disposed so as to be laminated together in the thickness direction, or may be disposed in a combined manner of both. The plurality of capacitor units 10 may be disposed in a regularly or irregularly. The sizes, the shapes, and the like of the capacitor units 10 may be the same or may differ partly or fully. The capacitor units 10 preferably have the same structure but may have different structures.

The capacitor unit 10 includes an anode plate 11 including a porous portion 11B on at least one main surface of a core portion 11A, a dielectric layer 13 provided on a surface of the porous portion 11B, and a cathode layer 12 provided on a surface of the dielectric layer 13. In the example illustrated in FIG. 1, the anode plate 11 includes the porous portions 11B on both main surfaces of the core portion 11A but may also include the porous portion 11B on only one of the main surfaces of the core portion 11A.

The cathode layer 12 includes a solid electrolyte layer 12A provided on the surface of the dielectric layer 13. The solid electrolyte layer 12A contains a conductive polymer. Since the cathode layer 12 includes the solid electrolyte layer 12A, the capacitor unit 10 constitutes a solid electrolyte capacitor.

The cathode layer 12 preferably further includes a conductive layer 12B provided on a surface of the solid electrolyte layer 12A.

As illustrated in FIG. 1, the sealing layers 20 are preferably provided on both main surfaces in the thickness direction of the capacitor unit 10. The capacitor unit 10 is protected by the sealing layer 20.

The sealing layer 20 may include only one layer or may include two or more layers. When the sealing layer 20 includes two or more layers, the materials of these layers may be the same or different.

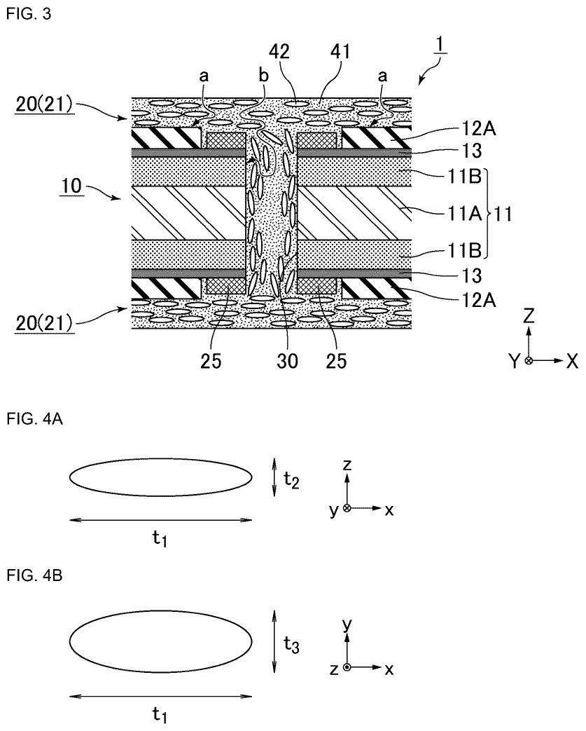

FIG. 3 is an enlarged view of the portion indicated by III in FIG. 1. In FIG. 3, the paths of oxygen and moisture are indicated by arrows.

As illustrated in FIG. 3, the sealing layer 20 contains an insulating resin 41 and flattened inorganic fillers 42. When the sealing layer 20 includes the first sealing layer 21 and the second sealing layer 22, at least the first sealing layer 21 only needs to contain the flattened inorganic fillers 42.

In a portion of the sealing layer 20 that covers the capacitor unit 10, the flattened inorganic fillers 42 are oriented in a surface direction orthogonal to the thickness direction. FIG. 3 schematically illustrates the flattened inorganic fillers 42 oriented in the X direction in the portion of the sealing layer 20 that covers the capacitor unit 10.

Gas does not easily pass through the flattened inorganic fillers 42 as compared with the insulating resin 41. When the flattened inorganic fillers 42 are oriented in the surface direction (for example, in any one direction parallel to an XY plane, such as the X direction), it is possible to lengthen the path through which oxygen and moisture diffuse and infiltrate via the sealing layer 20 to the upper surface (or the lower surface) of the capacitor unit 10, as indicated by arrow a in FIG. 3. Accordingly, the degradation of the conductive resin contained in the solid electrolyte layer 12A can be suppressed. As a result, the lifetime characteristics of the capacitor element can be improved.

The flattened inorganic fillers 42 are preferably inorganic fillers with an oblateness measured according to the following definition of ½ or more. The corner portions of the flattened inorganic fillers 42 may be rounded in terms of enhancement of fluidity in the sealing layer 20. In addition, the shape of the flattened inorganic fillers 42 may be fibrous.

FIGS. 4A and 4B are schematic diagrams for describing the oblateness of the inorganic fillers.

As illustrated in FIGS. 4A and 4B, in the cross-sectional shape of the inorganic filler, the direction in which the dimension of the inorganic filler is minimized is defined as the z direction. Of the two directions orthogonal to the z direction, the direction in which the dimension of the inorganic filler increases is defined as the x direction, and the direction in which the dimension decreases is defined as the y direction. In addition, when the dimension in the x direction is a major axis t₁ and the dimension in the z direction is a minor axis t₂, the oblateness f is expressed as f=1−(t₂/t₁). When the shape of the inorganic fillers is spherical (with a circular cross-section), the oblateness is 0. When the particle is completely flattened, the oblateness is 1.

As described above, the oblateness of the flattened inorganic filler 42 is preferably ½ or more. That is, the length of the major axis t₁ is preferably at least twice the length of the minor axis t₂ (2×t₂≤t₁). On the other hand, when the dimension in the y direction is a medium axis t₃, the medium axis t₃ is preferably 2×t₂≤t₃≤t₁.

It should be noted that, when the oblateness of inorganic fillers in a finished capacitor element is measured, a portion of the sealing layer is cut out from the capacitor element, the resin component is removed, and then the oblateness of the inorganic filler can be measured through observation using an electron microscope, such as a scanning electron microscope (SEM).

When the length of the major axis of the flattened inorganic fillers 42 is too small, the orientation is less likely to be obtained. Accordingly, the length of the major axis of the flattened inorganic fillers 42 is preferably 100 nm or more. On the other hand, the length of the major axis of the flattened inorganic fillers 42 is, for example, 10 μm or less.

When the length of minor axis of the flattened inorganic fillers 42 is too large, the resistance is likely to increase. Accordingly, the length of the minor axis of the flattened inorganic fillers 42 is preferably 5 μm or less. On the other hand, the length of the minor axis of the flattened inorganic fillers 42 is, for example, 50 nm or more.

In this specification, “the flattened inorganic filler is oriented in the surface direction” means that the orientation ratio obtained by the following method is 60% or more.

An orientation ratio OR₁ in the surface direction is expressed by the formula OR₁=(N′₁/N₁)×100 where, in one cross-section as illustrated in FIG. 3, N₁ is the total number of flattened inorganic fillers 42 to be measured, and N′₁ is the number of flattened inorganic fillers 42 for which the inclination θ₁ of the flattened inorganic fillers 42 in the major axis direction with respect to the surface direction satisfies −30°≤θ₁≤30°. For example, in the portion of the sealing layer 20 that covers the capacitor unit 10, at least 10 flattened inorganic fillers 42 located at positions away from a penetration portion, such as the through-groove 30, are preferably to be measured.

In the portion of the sealing layer 20 that covers the capacitor unit 10, the orientation ratio of the flattened inorganic fillers 42 in the surface direction is preferably 70% or more, more preferably 80% or more. On the other hand, in the portion of the sealing layer 20 that covers the capacitor unit 10, the orientation ratio of the flattened inorganic filler 42 in the surface direction only needs to be 100% or less and may also be 100%.

The filling ratio of the flattened inorganic fillers 42 in the sealing layer 20 (for example, the first sealing layer 21) is preferably 20% or more, more preferably 30% or more. On the other hand, the filling ratio of the flattened inorganic fillers 42 is preferably 60% or less, more preferably 50% or less. In one cross-section as illustrated in FIG. 3, the filling ratio of the flattened inorganic fillers 42 can be calculated as the ratio of the area of the flattened inorganic fillers 42 in the sealing layer 20 (for example, the first sealing layer 21).

When adjacent capacitor units 10 are separated from each other by the through-groove 30 and the through-groove 30 is filled with the sealing layer 20 (for example, the first sealing layer 21), the flattened inorganic fillers 42 are preferably oriented in the thickness direction in the portion of the sealing layer 20 with which the through-groove 30 is filled. FIG. 3 schematically illustrates the flattened inorganic fillers 42 oriented in the Z direction in the portion of the sealing layer 20 with which the through-groove 30 is filled.

When the flattened inorganic fillers 42 are oriented in the thickness direction (Z direction), the path through which oxygen and moisture diffuse and infiltrate to the side surface of the capacitor unit 10 via the sealing layer 20 can be lengthened, as indicated by arrow b in FIG. 3. Accordingly, the degradation of the conductive resin contained in the solid electrolyte layer 12A can be suppressed. As a result, the lifetime characteristics of the capacitor element 1 can be improved.

In addition, when the flattened inorganic fillers 42 through which gas does not easily pass are oriented in the thickness direction with respect to the through-groove 30 to which the core portion 11A and the porous portions 11B of the anode plate 11 are exposed, the effect of suppressing the diffusion and infiltration of oxygen and moisture is enhanced.

In this specification, “the flattened inorganic filler is oriented in the thickness direction” means that the orientation ratio obtained by the following method is 60% or more.

An orientation ratio OR₂ in the thickness direction is expressed by the formula OR₂=(N′₂/N₂)×100 where, in one cross-section as illustrated in FIG. 3, N₂ is the total number of flattened inorganic fillers 42 to be measured, and N′₂ is the number of flattened inorganic fillers 42 for which an inclination θ₂ of the flattened inorganic fillers 42 in the major axis direction with respect to the thickness direction satisfies −30°≤θ₂≤30°. For example, at least 10 flattened inorganic fillers 42 located at the center in the thickness direction are preferably to be measured in the portion of the sealing layer 20 with which penetration portions, such as the through-groove 30, are filled.

In the portion of the sealing layer 20 with which the through-groove 30 is filled, the orientation ratio of the flattened inorganic filler 42 in the thickness direction is preferably 70% or more at the center in the thickness direction of the through-groove 30, more preferably 80% or more. On the other hand, in the portion of the sealing layer 20 with which the through-groove 30 is filled, the orientation ratio of the flattened inorganic filler 42 in the thickness direction only needs to be 100% or less at the center in the thickness direction of the through-groove 30 and may also be 100%.

When the through-groove 30 is filled with the sealing layer 20 (for example, the first sealing layer 21), the length of the major axis of the flattened inorganic fillers 42 is preferably ⅓ or less of the width of the through-groove 30 (the length indicated by W₃₀ in FIGS. 1 and 2), more preferably ⅕ or less. Since the flattened inorganic fillers 42 are not too large in this case, clogging with the flattened inorganic fillers 42 is less likely to occur when the through-groove 30 is filled with the sealing layer 20 (for example, the first sealing layer 21). It should be noted that, when the width of the through-groove 30 is not constant, the width of the narrowest portion is defined as the width of the through-groove 30.

The lower limit of the length of the major axis of the flattened inorganic fillers 42 is not particularly limited, but the length of the major axis of the flattened inorganic fillers 42 is preferably 1/40 or more of the width of the through-groove 30, more preferably 1/20 or more.

As illustrated in FIGS. 1 and 2, the capacitor element 1 preferably further includes a first through-hole conductor 51 electrically connected to the cathode layer 12 and a second through-hole conductor 52 electrically connected to the anode plate 11. The capacitor element 1 may include both the first through-hole conductor 51 and the second through-hole conductor 52 or may include any one of them.

Although not illustrated in FIGS. 1 and 2, the capacitor element 1 may further include a third through-hole conductor that is not electrically connected to the anode plate 11 or the cathode layer 12.

The first through-hole conductor 51 only needs to be provided on at least the inner wall surface of the first through-hole 31 that passes through the capacitor unit 10 and the sealing layer 20 in the thickness direction. The first through-hole conductor 51 may be provided only on the inner wall surface of the first through-hole 31 or may also be provided in the entire inside of the first through-hole 31.

In plan view in the thickness direction, one first through-hole conductor 51 or two or more first through-hole conductors 51 may be provided in the cathode layer 12.

As illustrated in FIG. 1, a space between the end face of the anode plate 11 and the first through-hole conductor 51 is preferably filled with an insulating material, such as a sealing layer 20.

When the space between the end face of the anode plate 11 and the first through-hole conductor 51 is filled with the sealing layer 20 (for example, the first sealing layer 21), although not illustrated in FIG. 1, the flattened inorganic fillers 42 are preferably oriented in the thickness direction in the portion of the sealing layer 20 with which the space between the end face of the anode plate 11 and the first through-hole conductor 51 is filled.

When the flattened inorganic fillers 42 are oriented in the thickness direction, as in FIG. 3, the path through which oxygen and moisture diffuse and infiltrate to the side surface of the capacitor unit 10 via the sealing layer 20 can be lengthened. Accordingly, the degradation of the conductive resin contained in the solid electrolyte layer 12A can be suppressed. As a result, the lifetime characteristics of the capacitor element 1 can be improved.

In addition, since the flattened inorganic fillers 42 have a higher thermal conductivity than the insulating resin 41, it is possible to efficiently dissipate the heat generated by the current flowing through the first through-hole conductor 51 electrically connected to the cathode layer 12. Furthermore, even when the first through-hole conductor 51 generates heat due to its small resistance, this heat can be easily dissipated to the outside.

In the portion of the sealing layer 20 with which the space between the end face of the anode plate 11 and the first through-hole conductor 51 is filled, the orientation ratio of the flattened inorganic filler 42 in the thickness direction is preferably 70% or more at the center in the thickness direction of the first through-hole conductor 51, more preferably 80% or more. On the other hand, in the portion of the sealing layer 20 with which the space between the end face of the anode plate 11 and the first through-hole conductor 51 is filled, the orientation ratio of the flattened inorganic filler 42 in the thickness direction only needs to be 100% or less at the center in the thickness direction of the first through-hole conductor 51 and may also be 100%.

When the space between the end face of the anode plate 11 and the first through-hole conductor 51 is filled with the sealing layer 20 (for example, the first sealing layer 21), the length of the major axis of the flattened inorganic fillers 42 is preferably ⅕ or less of the diameter of the first through-hole conductor 51 (the length indicated by D₅₁ in FIGS. 1 and 2). Since the flattened inorganic fillers 42 are not too large in this case, clogging with the flattened inorganic fillers 42 is less likely to occur when the space between the end face of the anode plate 11 and the first through-hole conductor 51 is filled with the sealing layer 20 (for example, the first sealing layer 21). It should be noted that, when the width of the through-groove 30 is not constant, the width of the narrowest portion is defined as the diameter of the first through-hole conductor 51.

The lower limit of the length of the major axis of the flattened inorganic fillers 42 is not particularly limited, but the length of the major axis of the flattened inorganic fillers 42 is preferably 1/40 or more of the diameter of the first through-hole conductor 51, more preferably 1/20 or more.

When the first through-hole conductor 51 is provided only on the inner wall surface of the first through-hole 31, the first resin filled portion 61 filled with a resin material may be provided inside the first through-hole conductor 51. In this case, the first resin filled portion 61 is provided in the space surrounded by the first through-hole conductor 51 in the first through-hole 31. When the space in the first through-hole 31 is eliminated because the first resin filled portion 61 is provided, the occurrence of delamination of the first through-hole conductor 51 is suppressed. The first resin filled portion 61 may be a conductor or an insulator.

The first resin filled portion 61 may contain an insulating resin and flattened inorganic fillers as in the sealing layer 20 (for example, the first sealing layer 21). In this case, the insulating resin contained in the first resin filled portion 61 may be the same as or different from the insulating resin contained in the sealing layer 20. In addition, the flattened inorganic fillers contained in the first resin filled portion 61 may be the same as or different from the flattened inorganic fillers contained in the sealing layer 20.

When the first resin filled portion 61 containing an insulating resin and flattened inorganic fillers is provided inside the first through-hole conductor 51, although not illustrated in FIG. 1, the flattened inorganic fillers are preferably oriented in the thickness direction in the first resin filled portion 61.

In the first resin filled portion 61, the orientation

ratio of the flattened inorganic fillers in the thickness direction is preferably 70% or more at the center of the first through-hole conductor 51 in the thickness direction, more preferably 80% or more. On the other hand, in the first resin filled portion 61, the orientation ratio of the flattened inorganic fillers in the thickness direction only needs to be 100% or less at the center of the first through-hole conductor 51 in the thickness direction and may also be 100%.

The second through-hole conductor 52 only needs to be provided on at least the inner wall surface of the second through-hole 32 that passes through the capacitor unit 10 and the sealing layer 20 in the thickness direction. The second through-hole conductor 52 may be provided on only the inner wall surface of the second through-hole 32 or may be provided in the entire inside of the second through-hole 32.

In plan view in the thickness direction, one second through-hole conductor 52 or two or more second through-hole conductors 52 may be provided in the cathode layer 12.

As illustrated in FIG. 1, the second through-hole conductor 52 is preferably electrically connected to the anode plate 11 on the inner wall surface of the second through-hole 32.

When the second through-hole conductor 52 is provided only on the inner wall surface of the second through-hole 32, the second resin filled portion 62 filled with a resin material may be provided inside the second through-hole conductor 52. In this case, the second resin filled portion 62 is provided in the space surrounded by the second through-hole conductor 52 in the second through-hole 32. When the space in the second through-hole 32 is eliminated because the second resin filled portion 62 is provided, the occurrence of delamination of the second through-hole conductor 52 is suppressed. The second resin filled portion 62 may be a conductor or an insulator.

Like the sealing layer 20 (for example, the first sealing layer 21), the second resin filled portion 62 may contain an insulating resin and flattened inorganic fillers. In this case, the insulating resin contained in the second resin filled portion 62 may be the same as or different from the insulating resin contained in the sealing layer 20. In addition, the flattened inorganic fillers contained in the second resin filled portion 62 may be the same as or different from the flattened inorganic fillers contained in the sealing layer 20.

When the second resin filled portion 62 containing the insulating resin and the flattened inorganic fillers is provided inside the second through-hole conductor 52, although not illustrated in FIG. 1, the flattened inorganic fillers are preferably oriented in the thickness direction in the second resin filled portion 62.

In the second resin filled portion 62, the orientation ratio of the flattened inorganic fillers in the thickness direction is preferably 70% or more at the center of the second through-hole conductor 52 in the thickness direction, more preferably 80% or more. On the other hand, in the second resin filled portion 62, the orientation ratio of the flattened inorganic fillers in the thickness direction only needs to be 100% or less at the center of the second through-hole conductor 52 in the thickness direction and may also be 100%.

The insulating resin 41 included in the sealing layer 20 (for example, the first sealing layer 21) preferably includes an epoxy resin or a phenolic resin. For example, when the capacitor element 1 is disposed on the surface of a resin board, an epoxy resin or a phenolic resin is often used on the surface of the resin substrate. Accordingly, since an epoxy resin or a phenolic resin is included in the insulating resin 41, junction between the capacitor element 1 and the resin board is improved. In addition, occurrence of delamination at the junction surface can be suppressed due to the mutual diffusion of resin and the anchoring effect caused by irregularities of the inorganic fillers.

The flattened inorganic fillers 42 contained in the sealing layer 20 (for example, the first sealing layer 21) are not particularly limited as long as they have insulating properties, but preferably include one or more of inorganic glass and silicate compounds. A flattened object can be easily formed by using these insulating inorganic materials.

In addition, generation of debris can be suppressed by using a material that is easy to machine when laser machining is performed on the sealing layer 20. As a result, the insulating properties of the sealing layer 20 can be ensured.

The inorganic glass can be, for example, glass fiber. The silicate compounds may be, for example, minerals, such as mica and montmorillonite. These insulating inorganic materials may be divided and crushed.

The flattened inorganic fillers 42 may be an insulating inorganic material that has been subjected to hydroxylation treatment. The contact angle can be reduced by hydroxylation treatment.

The sealing layer 20, such as the first sealing layer 21 is formed so as to seal the capacitor unit 10 by using, for example, a method that applies an insulating paste containing the insulating resin 41 and the flattened inorganic fillers 42 and thermally hardens the applied insulating paste.

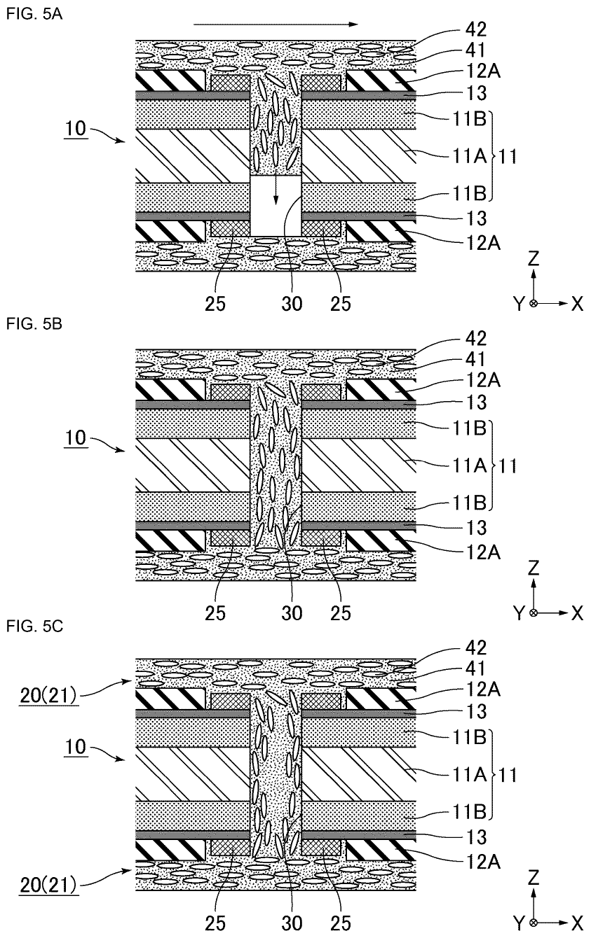

FIGS. 5A, 5B, and 5C are schematic diagrams for describing an example of a method of forming the sealing layer.

As illustrated in FIG. 5A, since the viscosity of the insulating resin 41 is low while the insulating paste is applied to the surface of the capacitor unit 10, the flattened inorganic fillers 42 are oriented along the flow (indicated by the arrows in FIG. 5A) of the insulating resin 41 and the insulating resin 41 flows through penetration portions, such as the through-groove 30. In this case, a portion of the flattened inorganic filler 42 that has a small area is the front end.

Since the orientation of the flattened inorganic filler 42 is relaxed over time, and sedimentation of the flattened inorganic filler 42 occurs, the insulating resin 41 needs to be quickly poured into penetration portions, such as the through-groove 30.

After the insulating paste is applied to the surface of the capacitor unit 10 as illustrated in FIG. 5B, the flattened inorganic filler 42 tends to gather onto the side surface of the capacitor unit 10 due to the surface tension as illustrated in FIG. 5C, and accordingly, the flattened inorganic fillers 42 at the center portion are reduced. On the other hand, on the upper surface or the lower surface of the capacitor unit 10, the flattened inorganic fillers 42 are oriented in the surface direction in which the insulating paste is applied.

As a result, the sealing layer 20 (for example, the first sealing layer 21) is formed.

The method of applying the insulating paste is preferably screen printing but is not limited to this, and the method can also be, for example, dispensing.

When the insulating paste is applied into the penetration portion of the through-groove 30, suction from the coating back surface is preferably performed. Since the flow of the insulating resin 41 can be accelerated, the flattened inorganic filler 42 can be oriented.

As illustrated in FIG. 1, the capacitor element 1 is preferably provided so as to pass through the sealing layer 20 in the thickness direction and preferably further includes a via conductor 70 having one end portion extended to the surface of the sealing layer 20.

In the example illustrated in FIG. 1, the via conductor 70 is electrically connected to the cathode layer 12. As a result, the cathode layer 12 is electrically led to the outside of the sealing layer 20 via the via conductor 70 and can be electrically connect to the outside of the sealing layer 20. The number of via conductors 70 electrically connected to the cathode layer 12 may be one or more than one.

Although not illustrated in FIG. 1, the capacitor element 1 may include the via conductor 70 electrically connected to the anode plate 11. In this case, the anode plate 11 is electrically led to the outside of the sealing layer 20 via the via conductor 70 and can be electrically connected to the outside of the sealing layer 20. The number of via conductors 70 electrically connected to the anode plate 11 may be one or more than one.

When the first through-hole conductor 51 or the second through-hole conductor 52 is provided inside the sealing layer 20, the capacitor unit 10 preferably further includes an insulating mask layer 25 provided around the first through-hole conductor 51 or the second through-hole conductor 52 on at least one main surface of the anode plate 11.

In the example illustrated in FIGS. 1 and 2, the space between the first through-hole conductor 51 and the capacitor unit 10 is filled with the insulating material, such as the sealing layer 20, and an insulating mask layer 25 is provided between this insulating material and the cathode layer 12. In addition, the example illustrated in FIGS. 1 and 2, the insulating mask layer 25 is provided between the second through-hole conductor 52 and the cathode layer 12.

The capacitor unit 10 may further include the insulating mask layer 25 provided so as to surround the cathode layer 12 on at least one main surface of the anode plate 11. When the cathode layer 12 is surrounded by the insulating mask layer 25 as illustrated in FIG. 2, the insulating properties between the anode plate 11 and the cathode layer 12 are ensured, and a short circuit therebetween are prevented. The insulating mask layer 25 may be provided so as to partly surround the cathode layer 12 but is preferably provided so as to fully surround the cathode layer 12.

As illustrated in FIG. 1, the capacitor element 1 may further include a first outer electrode layer 81 electrically connected to the cathode layer 12 and a second outer electrode layer 82 electrically connected to the anode plate 11.

The first outer electrode layer 81 is provided on the surface of the sealing layer 20.

One capacitor unit 10 or a plurality of first outer electrode layers 81 may be provided for one first outer electrode layer 81.

The planar shape of the first outer electrode layer 81 as viewed in the thickness direction is not particularly limited and can be, for example, a right quadrilateral (square or rectangle), a quadrilateral other than a right quadrilateral, a polygon such as a triangle, a pentagon, or a hexagon, a circle, an ellipse, a combination of these shapes, or the like. Alternatively, the planar shape of the first outer electrode layer 81 may also be an L-shape, a C-shape (U-shape), a stair-shape, or the like.

The second outer electrode layer 82 is provided on the surface of the sealing layer 20.

One second outer electrode layer 82 or a plurality of second outer electrode layers 82 may be provided for one capacitor unit 10. The number of second outer electrode layers 82 for one capacitor unit 10 may be the same as or different from the number of first outer electrode layers 81.

The planar shape of the second outer electrode layer 82 as viewed in the thickness direction is not particularly limited and can be, for example, a right quadrilateral (square or rectangle), a quadrilateral other than a right quadrilateral, a polygon such as a triangle, a pentagon, or a hexagon, a circle, an ellipse, a combination of these shapes, or the like. Alternatively, the planar shape of the second outer electrode layer 82 may also be an L-shape, a C-shape (U-shape), a stair-shape, or the like. The planar shape of the second outer electrode layer 82 as viewed in the thickness direction may be the same as or different from the planar shape of the first outer electrode layer 81 as viewed in the thickness direction.

The detailed structure of the capacitor element 1 will be described below.

The planar shape of the capacitor unit 10 as viewed in the thickness direction can be, for example, a right quadrilateral (square or rectangle), a quadrilateral other than a right quadrilateral, a polygon such as a triangle, a pentagon, or a hexagon, a circle, an ellipse, a combination of these shapes, or the like. Alternatively, the planar shape of the capacitor unit 10 may also be an L-shape, a C-shape (U-shape), a stair-shape, or the like.

The anode plate 11 is preferably made of a valve metal that exhibits a so-called valve action. The valve metal can be, for example, a single metal such as aluminum, tantalum, niobium, titanium, or zirconium, or an alloy containing at least one of these metals. Of these metals, aluminum or aluminum alloy is preferable.

The shape of the anode plate 11 is preferably planar, more preferably foil-shaped. As described above, the term “planar” also includes “foil-shaped” in this specification.

The anode plate 11 only needs to have the porous portion 11B on at least one main surface of the core portion 11A. That is, the anode plate 11 may have the porous portion 11B on only one main surface of the core portion 11A or may have the porous portions 11B on both main surfaces of the core portion 11A. The porous portion 11B is preferably a porous layer formed on the surface of the core portion 11A and is more preferably an etching layer.

The thickness of the anode plate 11 before an etching process is preferably 60 μm to 200 μm. The thickness of the unetched core portion 11A after the etching process is preferably 15 μm to 70 μm. The thickness of the porous portion 11B, which is designed according to the required dielectric strength and electrostatic capacity, is preferably 10 μm to 180 μm, including the thicknesses of the porous portions 11B on both sides of the core portion 11A.

The pore diameter of the porous portion 11B is preferably 10 nm to 600 nm. It should be noted that the pore diameter of the porous portion 11B refers to a median diameter D50 measured by a mercury porosimeter. The pore diameter of the porous portion 11B can be controlled, for example, by adjusting various conditions of etching.

The dielectric layer 13 provided on the surface of the porous portion 11B is porous by reflecting the surface condition of the porous portion 11B, and the surface thereof has a finely uneven shape. The dielectric layer 13 is preferably made from an oxide film of the valve metal described above. For example, when aluminum foil is used as the anode plate 11, the dielectric layer 13 made from an oxide film can be formed by performing anodic oxidation treatment (also referred to as chemical conversion treatment) on the surface of the aluminum foil in an aqueous solution containing ammonium adipate and the like.

The thickness of the dielectric layer 13, which is designed according to the required withstand voltage and electrostatic capacity, is preferably 10 nm to 100 nm.

The materials that constitute the solid electrolyte layer 12A included in the cathode layer 12 can be conductive polymers, such as polypyrroles, polythiophenes, or polyanilines. Of these conductive polymers, polythiophenes are preferable, and poly (3,4-ethylenedioxythiophene) referred to as PEDOT is particularly preferable. In addition, the conductive polymers described above may contain a dopant, such as polystyrene sulfonate (PSS). It should be noted that the solid electrolyte layer 12A preferably includes an inner layer with which the pores (recesses) of the dielectric layer 13 are filled and an outer layer that covers the dielectric layer 13.

The thickness of the solid electrolyte layer 12A from the surface of the porous portion 11B is preferably 2 μm to 20 μm.

The solid electrolyte layer 12A is formed by methods, such as a method that uses a treatment solution containing a monomer, such as 3,4-ethylenedioxythiophene, to create a polymer film of poly (3,4-ethylenedioxythiophene) or the like on the surface of the dielectric layer 13 or a method that applies a dispersion liquid of a polymer, such as poly (3,4-ethylenedioxythiophene) onto the surface of the dielectric layer 13 and dries the dispersion liquid.

The solid electrolyte layer 12A can be formed in a predetermined region by applying the processing solution or the dispersion liquid described above onto the surface of the dielectric layer 13 using a method, such as sponge transfer, screen printing, dispenser application, or inkjet printing.

When the cathode layer 12 includes the conductive layer 12B, the conductive layer 12B includes at least one of a conductive resin layer and a metal layer. The conductive layer 12B may include only a conductive resin layer or only a metal layer. The conductive layer 12B preferably covers the entire surface of the solid electrolyte layer 12A.

The conductive resin layer can be a conductive adhesive layer containing at least one type of conductive fillers selected from the group consisting of silver fillers, copper fillers, nickel fillers, and carbon fillers.

The metal layer can be, for example, a metal plating film or metal foil. The metal layer is preferably made of at least one type of metal selected from the group consisting of nickel, copper, silver, and alloy containing one of these metals as a main component. It should be noted that the term “main component” refers to the element with the largest weight ratio.

The conductive layer 12B includes, for example, a carbon layer provided on the surface of the solid electrolyte layer 12A and a copper layer provided on the surface of the carbon layer.

The carbon layer is provided to electrically and mechanically connect the solid electrolyte layer 12A and the copper layer to each other. The carbon layer can be formed in a predetermined region by applying a carbon paste onto the surface of the solid electrolyte layer 12A using a method, such as sponge transfer, screen printing, dispenser application, or inkjet printing. The thickness of the carbon layer is preferably 2 μm to 20 μm.

The copper layer can be formed in a predetermined area by applying a copper paste onto the surface of the carbon layer using a method, such as sponge transfer, screen printing, spray application, dispenser application, or inkjet printing. The thickness of the copper layer is preferably 2 μm to 20 μm.

When the sealing layer 20 includes two or more layers, the sealing layers other than the first sealing layer 21 may contain an insulating resin and flattened inorganic fillers as in the first sealing layer 21. In this case, the sealing layers other than the first sealing layer 21 may contain an insulating resin that is the same as that of the first sealing layer 21 or may contain an insulating resin that is different from that of the first sealing layer 21. In addition, the sealing layers other than the first sealing layer 21 may contain flattened inorganic fillers that are the same as those of the first sealing layer 21 or may contain flattened inorganic fillers that are different from those of the first sealing layer 21.

When the sealing layer 20 includes two or more layers, the sealing layers other than the first sealing layer 21 do not need to contain an insulating resin and flattened inorganic fillers unlike the first sealing layer 21. In this case, the sealing layers other than the first sealing layer 21 only need to include an insulating material.

For example, the sealing layers other than the first sealing layer 21 preferably contain an insulating resin.

The insulating resins contained in the sealing layers other than the first sealing layer 21 can be, for example, epoxy resin and phenolic resin.

The sealing layers other than the first sealing layer 21 preferably further contain inorganic fillers.

The inorganic fillers contained in the sealing layers other than the first sealing layer 21 can be, for example, silica particles and alumina particles.

Layers such as, for example, a stress relief layer or a moisture barrier film may be provided between the capacitor unit 10 and the sealing layer 20.

The insulating mask layer 25 includes an insulating material. In this case, the insulating mask layer 25 preferably includes an insulating resin.

The insulating resin that constitutes the insulating mask layer 25 can be, for example, polyphenylsulfone resin, polyethersulfone resin, cyanate ester resin, fluororesin (such as tetrafluoroethylene, tetrafluoroethylene-perfluoroalkyl vinyl ether copolymer), polyimide resin, polyamide-imide resin, epoxy resin, and their derivatives or precursors.

The insulating mask layer 25 may include a resin that is the same as that in the sealing layer 20. When the insulating mask layer 25 includes inorganic fillers unlike the sealing layer 20, since the effective capacitance portion of the capacitor unit 10 may be adversely affected, the insulating mask layer 25 is preferably made of a single resin.

The insulating mask layer 25 can be formed in a predetermined region by applying, for example, a mask material, such as a composition containing an insulating resin, onto the surface of the porous portion 11B by using a method, such as sponge transfer, screen printing, dispenser application, or inkjet printing.

The insulating mask layer 25 may be formed on the porous portion 11B before or after the time at which the dielectric layer 13 is formed.

The first outer electrode layer 81 is electrically connected to the cathode layer 12. In the example illustrated in FIG. 1, the first outer electrode layer 81 is provided on the surface of the first through-hole conductor 51 and functions as a connection terminal for the capacitor unit 10.

The constituent material of the first outer electrode layer 81 can be, for example, a metal material containing a low-resistance metal, such as silver, gold, or copper. In this case, the first outer electrode layer 81 is formed, for example, by performing a plating process on the surface of the first through-hole conductor 51.

A mixed material including a resin and at least one type of conductive fillers selected from the group consisting of silver fillers, copper fillers, nickel fillers, and carbon fillers may be used as the constituent material of the first outer electrode layer 81 to improve the close contact between the first outer electrode layer 81 and other members, specifically the close contact between the first outer electrode layer 81 and the first through-hole conductor 51.

The second outer electrode layer 82 is electrically connected to the anode plate 11. In the example illustrated in FIG. 1, the second outer electrode layer 82 is provided on the surface of the second through-hole conductor 52 and functions as a connection terminal for the capacitor unit 10. In the example illustrated in FIG. 1, the second outer electrode layer 82, which is electrically connected to the anode plate 11 via the second through-hole conductor 52, functions as a connection terminal for the anode plate 11.

The constituent material of the second outer electrode layer 82 can be, for example, a metal material containing a low-resistance metal, such as silver, gold, or copper. In this case, the second outer electrode layer 82 is formed, for example, by performing a plating process on the surface of the second through-hole conductor 52.

A mixed material including a resin and at least one type of conductive fillers selected from the group consisting of silver fillers, copper fillers, nickel fillers, and carbon fillers may be used as the constituent material of the second outer electrode layer 82 to improve the close contact between the second outer electrode layer 82 and other members, specifically the close contact between the second outer electrode layer 82 and the second through-hole conductor 52.

The constituent materials of the first outer electrode layer 81 and the second outer electrode layer 82 are preferably the same in at least the type, but these materials may also be different from each other.

The capacitor units 10 each include the first outer electrode layer 81 electrically connected to the cathode layer 12 and the second outer electrode layer 82 electrically connected to the anode plate 11 in the example illustrated in FIG. 1, but at least one of the first outer electrode layer 81 and the second outer electrode layer 82 may be shared by the plurality of capacitor units 10.

In the example illustrated in FIG. 1, the first outer electrode layer 81 and the second outer electrode layer 82 are provided on both main surfaces of the sealing layer 20 but may also be provided on only one main surface of the sealing layer 20.

In the example illustrated in FIG. 1, the first through-hole conductor 51 is electrically connected to the cathode layer 12 via the first outer electrode layer 81 and the via conductor 70.

In the example illustrated in FIG. 1, the first outer electrode layer 81, which is electrically connected to the cathode layer 12 via the via conductor 70, functions as a connection terminal for the cathode layer 12.

When the second through-hole conductor 52 is electrically connected to the anode plate 11 on the inner wall surface of the second through-hole 32, the second through-hole conductor 52 is preferably electrically connected to the end surface of the anode plate 11 facing the inner wall surface of the second through-hole 32. As a result, the anode plate 11 is electrically connected to the outside via the second through-hole conductor 52.

The core portion 11A and the porous portion 11B are preferably exposed to the end face of the anode plate 11 electrically connected to the second through-hole conductor 52. In this case, the porous portion 11B as well as the core portion 11A is also electrically connected to the second through-hole conductor 52.

The second through-hole conductor 52 is preferably electrically connected to the anode plate 11 over the entire circumference of the second through-hole 32 as viewed in the thickness direction. In this case, since the connection resistance between the anode plate 11 and the second through-hole conductor 52 is likely to decrease, the equivalent series resistance (ESR) is likely to decrease.

The first through-hole conductor 51 is formed, for example, as described below. First, a through-hole that passes through the capacitor unit 10 in the thickness direction is formed by performing drilling, laser processing, or the like. Next, the through-hole is filled with an insulating material. The first through-hole 31 is formed by performing drilling, laser machining, or the like on the portion filled with the insulating material. In this case, the diameter of the first through-hole 31 is made smaller than the diameter of the through-hole filled with insulating material, such that the insulating material is present between the inner wall surface of the through-hole having been formed first and the inner wall surface of the first through-hole 31 in the surface direction. After that, the inner wall surface of the first through-hole 31 is metallized with a metal material containing a low-resistance metal, such as copper, gold, or silver to form the first through-hole conductor 51. When the first through-hole conductor 51 is formed, machining becomes easier, for example, by the inner wall surface of the first through-hole 31 being metallized by electroless copper plating, electrolytic copper plating, or the like. It should be noted that the method of forming the first through-hole conductor 51 may also be a method that fills the first through-hole 31 with a metal material, a composite material of metal and resin, or the like, in addition to a method that metallizes the inner wall surface of the first through-hole 31.

The second through-hole conductor 52 is formed, for example, as described below. First, the second through-hole 32 that passes through the capacitor unit 10 and the sealing layer 20 in the thickness direction is formed by performing drilling, laser machining, or the like. After that, the inner wall surface of the second through-hole 32 is metallized with a metal material containing a low-resistance metal, such as copper, gold, or silver to form the second through-hole conductor 52. When the second through-hole conductor 52 is formed, machining becomes easier, for example, by the inner wall surface of the second through-hole 32 being metallized by electroless copper plating, electrolytic copper plating, or the like. It should be noted that the method of forming the second through-hole conductor 52 may also be a method that fills the second through-hole 32 with a metal material, a composite material of metal and resin, or the like, in addition to a method that metallizes the inner wall surface of the second through-hole 32.

An anode connection layer may be provided between the anode plate 11 and the second through-hole conductor 52 in the surface direction. That is, the anode plate 11 and the second through-hole conductor 52 may be electrically connected to each other via the anode connection layer.

Since the anode connection layer is provided between the anode plate 11 and the second through-hole conductor 52 in the surface direction, the anode connection layer functions as a barrier layer against the anode plate 11, more specifically as a barrier layer against the core portion 11A and the porous portion 11B. When the anode connection layer functions as a barrier layer against the anode plate 11, since the dissolution of the anode plate 11 during the liquid chemical treatment for forming outer electrode layers, such as the second outer electrode layer 82, is suppressed, and the infiltration of the liquid chemical into the capacitor unit 10 is also suppressed, reliability is likely to be improved.

The anode connection layer preferably includes a layer that contains nickel as a main component. In this case, since the damage to the metal (for example, aluminum) constituting the anode plate 11 is reduced, the barrier properties of the anode connection layer against the anode plate 11 are likely to be improved.

It should be noted that the anode connection layer does not need to be provided between the anode plate 11 and the second through-hole conductor 52 in the surface direction. In this case, the second through-hole conductor 52 may be directly connected to the end face of the anode plate 11.

The constituent material of the via conductor 70 can be, for example, a metal material containing a low-resistance metal, such as silver, gold, or copper.

The via conductor 70 is formed, for example, by performing plating, with the metal material described above, the inner wall surface of the through-hole that passes through the sealing layer 20 in the thickness direction or by performing heat treatment after filling the through-hole with a conductive paste.

The capacitor element according to the present disclosure is not limited to the embodiment described above, and various applications and modifications can be made to the structure and the manufacturing conditions of the capacitor element within the scope of the present disclosure.

In the capacitor element according to the present disclosure, a single capacitor unit may be disposed or a plurality of capacitor units may be disposed in the sealing layer.

The capacitor element according to the present disclosure can be suitably used as a constituent material for composite electronic components. Such a composite electronic component includes, for example, the capacitor element according to the present disclosure, an outer electrode layer, provided on the surface of the sealing layer of the capacitor element, that is electrically connected to the anode plate and the cathode layer of the capacitor element, and an electronic component connected to the outer electrode layer.

In the composite electronic component, an electronic component connected to the outer electrode layer may be a passive element or an active element. Both the passive element and the active element may be connected to the outer electrode layer, or either the passive element or the active element may be connected to the outer electrode layer. In addition, a composite body of the passive element and the active element may be connected to the outer electrode layer.

The passive element can be, for example, an inductor. The active element can be a memory, a graphical processing unit (GPU), a central processing unit (CPU), a micro processing unit (MPU), a power management IC (PMIC), or the like.

The capacitor element according to the present disclosure has a sheet-like shape as a whole. Accordingly, since the capacitor element can be treated like a mounting board in the composite electronic component, electronic components can be mounted on the capacitor element. In addition, when the shapes of electronic components mounted on the capacitor element are sheet-like, the capacitor element and the electronic components can be connected to each other in the thickness direction via a through-hole conductor that passes through the electronic components in the thickness direction. As a result, active elements and passive elements can be configured as a single module.

For example, the capacitor element according to the present disclosure can be electrically connected between a voltage regulator including a semiconductor active element and a load to which a converted DC voltage is supplied to form a switching regulator.

In the composite electronic component, after a circuit layer is formed on one surface of a capacitor matrix sheet on which the plurality of capacitor elements according to the present disclosure are laid out, connection to either a passive element or an active element may be made.

In addition, after the capacitor element according to the present disclosure is disposed in a cavity portion provided on the board in advance and is embedded in resin, a circuit layer may be formed on the resin. Another electronic component (passive element or active element) may be mounted in another cavity portion of this board.

Alternatively, after the capacitor element according to the present disclosure is mounted on a smooth carrier, such as a wafer or glass, an outer layer portion of resin is formed, and a circuit layer is formed, connection to either a passive element or an active element may be made.

### Examples

Examples that more specifically disclose the capacitor element according to the present disclosure will be described. It should be noted that the present disclosure is not limited to these examples.

### Preparation of Resin Paste Containing Inorganic Fillers

A paste was obtained by adding 30 volumes of inorganic fillers to 70 volume % of thermal hardening epoxy resin and mixing and stirring them with a centrifugal stirrer. The viscosity of the obtained paste was adjusted by ethanol.

Specifically, mica powder was used as flattened inorganic fillers. The mica powder with an average particle diameter of 3 μm, 5 μm, or 10 μm was prepared and dispersed in epoxy resin by using the centrifugal stirrer. A resin paste containing inorganic fillers was created by adjusting the viscosity to 2000 cP (2 Pa·s) using ethanol. A resin paste containing inorganic fillers was created for comparison by adding silica particles with an average particle diameter of 3 μm as spherical inorganic fillers.

### Creating Capacitor Element

Printing with the paste was performed so as to straddle the space between the conductive layers (Cu inner electrode layers) of the capacitor unit, and the paste was dried and hardened. After that, a through-hole for a through-hole conductor electrically connected to the cathode layer was formed by a laser, and the paste was injected into the through-hole by using a printing method. A method that promotes the fluidity of resin by a printing method that performs suction from the bottom surface and pressurization on the application surface was used to inject the paste.

After the paste is hardened, individual capacitor units were separated from each other by a laser along the X-axis direction to form a through-groove, and the printing with the paste is performed along this through-groove, and the paste is hardened. In addition, individual capacitor units are separated from each other by a laser along the Y-axis direction to form a through-groove, and, as in the X-axis, printing with the paste is performed, and the paste was hardened. After that, an epoxy resin film material with a thickness of 30 μm was thermally fused to obtain a capacitor element.

The first through-hole conductor electrically connected to the cathode layer and the second through-hole conductor electrically connected to the anode plate were formed in the obtained capacitor element. In addition, a via conductor was formed at a predetermined position so as to reach the Cu inner electrode layer by using a laser. After that, electroless copper plating treatment, electrolytic copper plating treatment, and pattern etching were performed to form the outer electrode layer.

The diameters of the first and second through-hole conductors were 50 μm, 70 μm, 100 μm, or 120 μm, and the minimum distance of the width of the through-groove was 15 μm, 30 μm, or 45 μm. The wider the through-groove that separates the capacitor unit, the better the insulating properties. However, since the processing time and the energy consumption of the laser increase, the upper limit was kept at 30 μm.

### Evaluation of Characteristics of Capacitor Element

The capacitor element having the first and second through-hole conductors with a diameter of 120 μm and the through-groove with a width of 30 μm was left in the atmosphere at 150° C., and the high-temperature lifetime characteristics were evaluated.

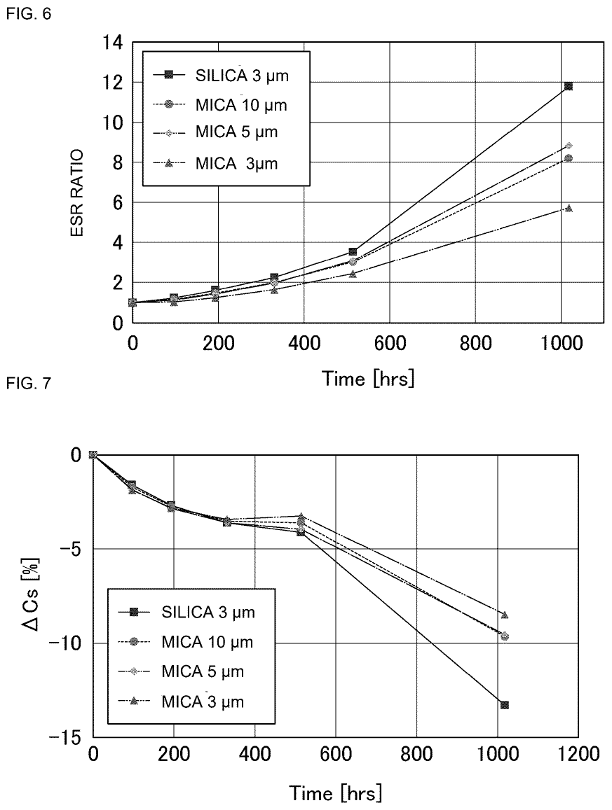

FIG. 6 is a graph illustrating the temporal change (ESR ratio) of ESR at 100 kHz. FIG. 7 is a graph illustrating the temporal change (ΔCs) of electrostatic capacity at 120 KHz.

It can be seen from FIGS. 6 and 7 that, when a sealing layer was formed by using an insulating resin to which flattened inorganic fillers (mica) were added, the equivalent series resistance (ESR) of the capacitor element was less likely to increase and the electrostatic capacity was less likely to decrease than when a sealing layer was formed by using an insulating resin to which spherical inorganic fillers (silica) were added. This result is thought to be obtained by suppression of the decomposition and degradation of conductive polymers in the solid electrolyte layer due to reduction in permeation of oxygen and moisture during the machining process.

### Evaluation of Printing State

The printing state of the resin paste containing inorganic fillers was evaluated while the diameter of the first through-hole conductor or the width of the through-groove was changed. The results are illustrated in Table 1.

TABLE 1

| | DIAMETER OF FIRST | | | | | | |
|---|---|---|---|---|---|---|---|
| | THROUGH-HOLE | | | | WIDTH OF THROUGH- | | |
| PRINTING | CONDUCTOR [μm] | | | | GROOVE [μm] | | |
| STATE | 50 | 70 | 100 | 120 | 15 | 30 | 45 |
| SILICA 3 μm | GOOD | GOOD | GOOD | GOOD | GOOD | GOOD | GOOD |
| (SPHERICAL) | | | | | | | |
| MICA 3 μm | GOOD | GOOD | GOOD | GOOD | GOOD | GOOD | GOOD |
| (FLATTENED) | | | | | | | |
| MICA 5 μm | GOOD | GOOD | GOOD | GOOD | MANY | GOOD | GOOD |
| (FLATTENED) | | | | | UNFILLED | | |
| | | | | | PORTIONS | | |
| | | | | | PRESENT | | |
| MICA 10 μm | GOOD | GOOD | GOOD | GOOD | MANY | MANY | UNFILLED |
| (FLATTENED) | | | | | UNFILLED | UNFILLED | PORTIONS |
| | | | | | PORTIONS | PORTIONS | PRESENT |
| | | | | | PRESENT | PRESENT | |

It can be seen from Table 1 that, when the flattened inorganic fillers (mica) are too large with respect to the width of the through-groove, clogging with the resin paste is likely to occur. In Table 1, “MANY UNFILLED PORTIONS PRESENT” indicates a void ratio of 10% or more in cross-sectioning. Similarly, “UNFILLED PORTIONS PRESENT” indicates a void ratio of less than 10%, and “GOOD” indicates a void ratio of less than 3%.

### Evaluation of Leakage Current

The insulating properties of the sealing layer that filled the space around the first through-hole conductor were evaluated by measuring the leakage current between the anode and the cathode of each of the capacitor units. In addition, the insulating properties of the sealing layer that filled the through-groove were evaluated by measuring the leakage current between the anodes of adjacent capacitor units. The results are illustrated in Table 2. When the printing state of the paste was particularly poor and many unfilled portions were present, the leakage current was not measured, and “−” was indicated in Table 2. The leakage current was measured by applying 2 VDC to the capacitor element and measuring the current flowing through the capacitor unit after 2 minutes. (The standard is a current value of 2 μA or less, which corresponds to an insulation resistance of 1 MΩ or more.)

TABLE 2

| | SPACING BETWEEN END FACE OF | | | | | | |
|---|---|---|---|---|---|---|---|
| LEAK | ANODE PLATE AND FIRST | | | | WIDTH OF THROUGH- | | |
| CURRENT | THROUGH-HOLE CONDUCTOR [μm] | | | | GROOVE [μm] | | |
| [μA] | 50 | 40 | 25 | 15 | 15 | 30 | 45 |
| SILICA 3 μm | 0.24 | 0.32 | 0.48 | 0.58 | 9.20 | 3.70 | 1.37 |
| (SPHERICAL) | | | | | | | |
| MICA 3 μm | 0.15 | 0.18 | 0.74 | 1.68 | 1.87 | 1.09 | 0.08 |
| (FLATTENED) | | | | | | | |
| MICA 5 μm | 0.20 | 0.47 | 1.86 | 5.85 | — | 0.95 | 0.10 |
| (FLATTENED) | | | | | | | |
| MICA 10 μm | 0.46 | 2.26 | 4.84 | 8.65 | — | — | 2.15 |
| (FLATTENED) | | | | | | | |

It can be seen from Table 2 that, in the sealing layer containing the spherical inorganic fillers (silica), as the width of the through-groove decreased, the leakage current increased and insulating properties decreased. On the other hand, it can be seen that, in the sealing layer containing the flattened inorganic fillers (mica), when the distance between the end face of the anode plate and the first through-hole conductor was too small with respect to the particle diameter of the inorganic fillers, the leakage current increased, and insulating properties decreased.

It is thought that the leakage current decreases and the insulating properties are enhanced as compared with spherical inorganic fillers due to the effect of the flattened inorganic fillers. Even in the inorganic fillers with insulating properties, surface current is likely to flow on the surface. Generally, as the surface distance increases, the surface current is less likely to flow. Accordingly, it is considered that the sealing layer containing the flattened inorganic fillers, which have a longer surface distance than the spherical inorganic fillers, can maintain higher insulating properties.

### Reference Signs List

1 capacitor element
10 capacitor unit
11 anode plate
11A core portion
11B porous portion
12 cathode layer
12A solid electrolyte layer
12B conductive layer
13 dielectric layer
20 sealing layer
21 first sealing layer
22 second sealing layer
25 insulating mask layer
30 through-groove
31 first through-hole
32 second through-hole
41 insulating resin
42 flattened inorganic filler
51 first through-hole conductor
52 second through-hole conductor
61 first resin filled portion
62 second resin filled portion
70 via conductor
81 first outer electrode layer
82 second outer electrode layer
D₅₁ diameter of first through-hole conductor
W₃₀ width of through-groove

1. A capacitor element comprising:
a capacitor unit including an anode plate including a core portion and a porous portion on at least one main surface of the core portion, a dielectric layer on a surface of the porous portion, and a cathode layer that includes a solid electrolyte layer on a surface of the dielectric layer, and the solid electrolyte layer contains a conductive polymer; and
a sealing layer covering the capacitor unit, wherein the sealing layer contains a first insulating resin and first flattened inorganic fillers, and the first flattened inorganic fillers are oriented in a surface direction orthogonal to a thickness direction in a portion of the sealing layer that covers the capacitor unit.

2. The capacitor element according to claim 1, further comprising:
a first through-hole conductor on at least an inner wall surface of a first through-hole that passes through the capacitor unit and the sealing layer in the thickness direction, the first through-hole conductor being electrically connected to the cathode layer,
wherein a space between an end face of the anode plate and the first through-hole conductor is filled with the sealing layer, and
the first flattened inorganic fillers are oriented in the thickness direction in a portion of the sealing layer with which the space between the end face of the anode plate and the first through-hole conductor is filled.

3. The capacitor element according to claim 2, wherein a length of a major axis of the first flattened inorganic fillers is ⅕ or less of a diameter of the first through-hole conductor.

4. The capacitor element according to claim 2, wherein, in the portion of the sealing layer with which the space between the end face of the anode plate and the first through-hole conductor is filled, an orientation ratio of the first flattened inorganic fillers in the thickness direction is 70% or more at a center of the first through-hole conductor in the thickness direction.

5. The capacitor element according to claim 2,
wherein a first resin filled portion containing a second insulating resin and second flattened inorganic fillers is inside the first through-hole conductor on the inner wall surface of the first through-hole, and
the second flattened inorganic fillers are oriented in the thickness direction in the first resin filled portion.

6. The capacitor element according to claim 5, wherein an orientation ratio of the second flattened inorganic fillers in the thickness direction is 70% or more at a center of the first through-hole conductor in the thickness direction in the first resin filled portion.

7. The capacitor element according to claim 1, further comprising:
a second through-hole conductor on at least an inner wall surface of a second through-hole that passes through the capacitor unit and the sealing layer in the thickness direction,
wherein the second through-hole conductor is electrically connected to the anode plate on the inner wall surface of the second through-hole.

8. The capacitor element according to claim 7,
wherein a second resin filled portion containing a third insulating resin and third flattened inorganic fillers is inside the second through-hole conductor on the inner wall surface of the second through-hole, and
the third flattened inorganic fillers are oriented in the thickness direction in the second resin filled portion.

9. The capacitor element according to claim 8, wherein an orientation ratio of the third flattened inorganic fillers in the thickness direction is 70% or more at a center of the second through-hole conductor in the thickness direction in the second resin filled portion.

10. The capacitor element according to claim 1,
wherein a plurality of capacitor units are disposed in the sealing layer, the capacitor unit being one of the plurality of capacitor units,
adjacent capacitor units of the plurality of capacitor units are separated from each other by a through-groove that passes through the capacitor units in the thickness direction,
the through-groove is filled with the sealing layer, and
the first flattened inorganic fillers are oriented in the thickness direction in a portion of the sealing layer with which the through-groove is filled.

11. The capacitor element according to claim 10, wherein a length of a major axis of the first flattened inorganic fillers is ⅓ or less of a width of the through-groove.

12. The capacitor element according to claim 10, wherein an orientation ratio of the first flattened inorganic fillers in the thickness direction is 70% or more at a center of the through-groove in the thickness direction in the portion of the sealing layer with which the through-groove is filled.

13. The capacitor element according to claim 1, wherein the first flattened inorganic fillers contained in the sealing layer include one or more of inorganic glass and a silicic acid compound.

14. The capacitor element according to claim 1, wherein the first insulating resin contained in the sealing layer includes epoxy resin or phenolic resin.

15. The capacitor element according to claim 1,
wherein the sealing layer includes a first sealing layer that covers the capacitor unit and a second sealing layer that covers the first sealing layer, and
at least the first sealing layer contains the first flattened inorganic fillers.

16. The capacitor element according to claim 1,
wherein a plurality of capacitor units are disposed in the sealing layer, the capacitor unit being one of the plurality of capacitor units,
adjacent capacitor units of the plurality of capacitor units are separated from each other by a through-groove that passes through the capacitor units in the thickness direction,
the through-groove is filled with the sealing layer, and
the first flattened inorganic fillers are oriented in the thickness direction in a portion of the sealing layer with which the through-groove is filled,
the capacitor element further comprising:
a first through-hole conductor on at least an inner wall surface of a first through-hole that passes through the capacitor unit and the sealing layer in the thickness direction, the first through-hole conductor being electrically connected to the cathode layer;
a second through-hole conductor on at least an inner wall surface of a second through-hole that passes through the capacitor unit and the sealing layer in the thickness direction, the second through-hole conductor being electrically connected to the anode plate on the inner wall surface of the second through-hole,
wherein a space between an end face of the anode plate and the first through-hole conductor is filled with the sealing layer, and
the first flattened inorganic fillers are oriented in the thickness direction in a portion of the sealing layer with which the space between the end face of the anode plate and the first through-hole conductor is filled.

17. The capacitor element according to claim 16,
wherein a first resin filled portion containing a second insulating resin and second flattened inorganic fillers is inside the first through-hole conductor on the inner wall surface of the first through-hole, and the second flattened inorganic fillers are oriented in the thickness direction in the first resin filled portion, and
wherein a second resin filled portion containing a third insulating resin and third flattened inorganic fillers is inside the second through-hole conductor on the inner wall surface of the second through-hole, and the third flattened inorganic fillers are oriented in the thickness direction in the second resin filled portion.

18. The capacitor element according to claim 17, wherein
in the portion of the sealing layer with which the space between the end face of the anode plate and the first through-hole conductor is filled, an orientation ratio of the first flattened inorganic fillers in the thickness direction is 70% or more at a center of the first through-hole conductor in the thickness direction,
an orientation ratio of the second flattened inorganic fillers in the thickness direction is 70% or more at a center of the first through-hole conductor in the thickness direction in the first resin filled portion, and
an orientation ratio of the third flattened inorganic fillers in the thickness direction is 70% or more at a center of the second through-hole conductor in the thickness direction in the second resin filled portion.

19. The capacitor element according to claim 18, wherein a length of a major axis of the first flattened inorganic fillers is ⅓ or less of a width of the through-groove.
